(19) United States
(12) Patent Application Publication
(10) Pub. No.: US 2009/0252943 A1
(43) Pub. Date: Oct. 8, 2009

(54) ADIABATIC SOUND ABSORBER WITH HIGH THERMOSTABILITY

(76) Inventors: Masaaki Takeda, Hyogo (JP); Hideo Nakamura, Hyogo (JP)

Correspondence Address: Kirschstein, Israel, Schiffmiller & Pieroni, P.C., 425 FIFTH AVENUE, 5TH FLOOR, NEW YORK, NY, 10016-2223, US

(21) Appl. No.: 12/310,056

(22) PCT Filed: Feb. 23, 2007
(86) PCT No.: PCT/JP2007/053370

§ 371 Date: Feb. 6, 2009

(30) Foreign Application Priority Data
Aug. 11, 2006 (JP) 2006-219222

(51) Int. Cl. B32B 27/02

(52) U.S. Cl. 428/220

(57) ABSTRACT

Provided is a flexible adiabatic sound absorber with high thermal insulation performance and acoustic performance, particularly an adiabatic sound absorbing material that is suitable for a new severe requirement specification regarding aircrafts. The adiabatic sound absorber comprises mixing uniformly 20 to 80% of a high-thermostable inorganic fiber whose high-temperature strength is maintained at 1000° C. or more, 10 to 60% of a flame-retarded organic fiber whose thermal melting or decomposition temperature is 350° C. or more and 10 to 25% of an organic fiber having a low melting point and treating the obtained woolly felt with heating to transform the whole into the mat-form material of 8 to 50 mm in thickness.

### TECHNICAL FIELD

The present invention relates to a flexible and thermostable adiabatic sound absorber with high thermal insulation performance and acoustic performance, more particularly it relates to an adiabatic sound absorbing material suitable for a new severe requirement specification for aircrafts.

### BACKGROUND ART

In Japan, a sound absorber molded into plates was used for railroad cars, in which a glass wool and rock fiber was impregnated with a small amount of organic synthetic resin, as disclosed in JP-S63-19622-B4. When the impregnated resin is combustible, this sound absorber generates a toxic gas during burning. The car weight is also apt to increase because the absorber is not lightweight. In JP-H06-47715-U, by which this defect was improved, a lap of a sintered flameproof acrylic fiber was punched with needles, on which a face sheet comprising a needle felt or woven cloth made of a sintered flameproof acrylic fiber was attached. The sound absorber thus obtained is relatively light so that the increase of the car weight is low. The sound absorber was therefore started to use for Japanese railroad cars including a train of the Shinkansen where a high thermostability is not necessary.

A sound absorber in which the aluminum sheet was attached to the surface of a glass wool was used conventionally for automobile acoustic materials. This sound absorber was insufficient for sound absorbency though it is proof against high temperature, when it was mounted in the vicinity of an exhaust muffler that became considerably a high temperature in an engine room. In JP-S59-227442-A2, a staple fiber having high softening point was scattered on non-woven synthetic fabrics, which was punched with needles. The thermostable face materials thus obtained was attached on the surface of a glass wool with an adhesive agent and then was transformed with heating and pressurization. On this sound absorber, thermal resistance of the face materials was insufficient to be used for an engine room where high thermal resistance was required because both a melting point of the staple fiber and the synthetic fabrics was 300° C. or less. As for a sound absorber disclosed in JP-2006-138935-A2, face materials were composed of a fiber sheet with a thermostable organic fiber having 370° C. or more of heat melting or thermal decomposition temperature, the face materials being attached on non-woven fabrics about 2 to 100 mm thick with a similar thermostable organic fiber. This sound absorbing materials had thermal resistance that was almost satisfied to automobile applications.

### [Cited Reference 1] JP-S63-19622-B4

### [Cited Reference 2] JP-H06-47715-U

### [Cited Reference 3] JP-S59-227442-A2

### [Cited Reference 4] JP-2006-138935-A2

### [Cited Reference 5] JP-2005-335279-A2

### DISCLOSURE OF INVENTION

### Problems to be Solved by the Invention

In a case that a thermal insulating sound absorber is used for aircrafts, the requirement of heat resistance and adiabaticity is very severe in consideration for a large number of victims damage and high dangerousness when an aircraft accident occurs, as compared with a general acoustic material for railroad or automobile cars. A sound absorber for aircrafts was composed of the primary non-woven fabric made of a general glass wool, rock fiber or heat resistant organic fiber and the face material attached on the surface of the non-woven fabric was similar to the material for an automobile. The sound absorber is difficult to be suitable for a requirement specification of a non-woven fabric for aircrafts in respect of adiabatic temperature and heat resistance.

In JP-2005-335279-A2, there was disclosed a sound absorber that was easy to be formed and was useful for interior parts of a railroad or automobile car or aircraft. As for the sound absorber, a face material was attached on the one side of a non-woven fabric, the face material containing a resin binder. Even if this acoustic material is effective in respect of formability, it is impossible to be suitable for a new requirement specification of a non-woven fabric for aircrafts due to the use of a non-woven fabric of an organic fiber similar to that mentioned above.

The present invention is proposed to improve the problem of high thermal insulation performance concerning a conventional sound absorbing material.

It is an object of this invention to provide a sound absorbing material that has high safety by virtue of especially high adiabaticity and sound absorbency.

Another object of the present invention is to provide a sound absorbing material that is flexible according to the arrangement thereof and that achieves high adiabaticity and sound absorbency.

Further object of the present invention is to provide a sound absorbing material for aircrafts that is suitable for a new requirement specification of non-woven fabric regarding aircrafts.

### Means for Solving the Problem

For an adiabatic sound absorber according to the present invention, the mat-form material is not holed by taking a combustion test in contacting a blaze of a gas burner for 5 minutes and it is also possible to hold a hand up behind the mat-form material during the combustion test. The adiabatic sound absorber of the present invention may be manufactured by mixing uniformly 20 to 80% of a high-thermostable inorganic fiber whose high-temperature strength is maintained at 1000° C. or more, 10 to 60% of a flame-retarded organic fiber whose thermal melting or decomposition temperature is 350° C. or more and 10 to 25% of an organic fiber having a low melting point. As for the adiabatic sound absorber of the present invention, the obtained woolly felt is then treated with heating to transform the whole into the mat-form material of 8 to 50 mm in thickness. On manufacturing this adiabatic sound absorber, each raw fiber or the woolly felt may be impregnated with liquid water repellent to add water repellency to the woolly felt.

Another adiabatic sound absorber according to the present invention may be manufactured by mixing uniformly 20 to 80% of a high-thermostable inorganic fiber whose high-temperature strength is maintained at 1000° C. or more and 10 to 60% of a flame-retarded organic fiber whose thermal melting or decomposition temperature is 350° C. or more and impregnating the obtained woolly felt with 10 to 25% by dry measure of a thermostable resin binder. As for the adiabatic sound absorber of the present invention, the woolly felt is then transformed into the mat-form material with the resin binder, the mat-form material being 8 to 50 mm in thickness. On manufacturing this adiabatic sound absorber, the woolly felt may be impregnated with liquid water repellent only or together with the resin binder to add water repellency to the woolly felt.

In the adiabatic sound absorber of the present invention, it is preferable that the high-thermostable inorganic fiber is a silica fiber, a S-glass fiber, a silicon carbide fiber, a boron fiber, an alumina silicate fiber, an alkaline titanate fiber and/or a ceramic fiber, particularly a silica fiber is preferable. It is also preferable that the flame-retarded organic fiber is a meta-aramid fiber, a para-aramid fiber, a melamine fiber, a polybenzoxazole (PBO) fiber, a polybenzimidazole (PBI) fiber, a polybenzothiazole fiber, a polyarylate (U polymer) fiber, a polyethersulfone (PES) fiber, a liquid crystalline polyester (LCP) fiber, a polyphenylene sulfide (PPS) fiber, a polyimide (PI) fiber, a polyetherimide (PEI) fiber, a polyether-ether-ketone (PEEK) fiber, a polyether-ketone (PEK) fiber, a polyether-ketone-ketone fiber (PEKK) and/or polyamide-imide (PAI) fiber.

In the adiabatic sound absorber of the present invention, it is possible that each raw fiber is treated beforehand with chemicals containing a water repellent and/or a flame retardant before mixing the raw fibers. A flame-retarded resin may be added furthermore to at least one surface of the adiabatic sound absorber. It is desirable that a surface smoothing treatment is applied furthermore to the mat-form sound absorbing material with needle-punching, singeing or calendering.

Illustrating the adiabatic sound absorber of the present invention in more detail, it is desirable that a quantity of a high-thermostable inorganic fiber on a primary component is 20 to 80% by weight of the whole. When a quantity of the inorganic fiber is less than 20% by weight of the whole fibers, it becomes difficult to suit the sound absorber to a new requirement specification for aircrafts with regard to high heat resistance and thermal insulation performance. Meanwhile, when the inorganic fiber is applied above 20% by weight of the whole, the sound absorber is suitable to the new requirement specification for aircrafts and is generally advantageous to economic condition. When it is over 80% by weight, however, the sound absorber lacks flexibility.

As for adiabatic sound absorber of the present invention, a high-thermostable inorganic fiber on a primary component needs to maintain high temperature strength at 1000° C. or more. On a thermal melting temperature, a S-glass is 1493° C. and an E-glass is 1121° C., but high-temperature strength of the E-glass decreases drastically at about 800° C., therefore the S-glass fiber is only available among these glass fibers. Even if a metal fiber and a carbon fiber such as a nickel fiber, a tungsten fiber and a titanium fiber are available in the point of a thermal heat melting temperature, the adiabaticity of the mat-form material falls down because the coefficient of thermal conductivity of these metal and carbon fibers is high in general. A stainless steel fiber is fragile on the occasion of heating for a long time at 700 to 800° C. even if it has a melting point of 1050° C.

As a suitable high-thermostable inorganic fiber, therefore, there may be exemplified a silica fiber, a S-glass fiber, a silicon carbide fiber, the boron filament, and single or the mixture of the alumino silicate fiber, a alkaline titanate fiber and/or a ceramic fiber. It is possible that a metal fiber may be added by way of a part of the high-thermostable inorganic fiber. Especially it is preferable that the silica fiber is mainly used among these inorganic fibers.

A silica fiber is called a silica-glass fiber in turn. The silica fiber may be manufactured by baking after eliminating soluble and organic components from a proto-fiber. The silica fiber is, for instance, manufactured by the step of making a staple fiber from an E-glass, a soda silica glass, a borosilicate glass or a soda lime glass with blowing, acidifying the staple fiber to dissolve soluble component and baking the fiber to form skeletal silica, a silica portion thereof attaining to about 95% or more. It is preferable that an E-glass fiber having less than 1% of alkali content, namely, a boron silicate glass is generally used as a proto-fibber of the silica fiber in respect of cost and physical properties.

When the adiabatic sound absorber of the present invention contains a proper quantity of a flame-retarded organic fiber whose heat melting or thermal decomposition temperature is 350° C. or more, it may have appropriate transformability and flexibility. Also, a card-forming rate including a card-passage degree and the like gets better and there is improved the ratio of the sound absorber to the raw fibers.

On the occasion of containing a high-thermostable inorganic fiber and a low-melting organic fiber together, it is desirable that 10 to 60% by weight of a flame-retarded organic fiber is added to the sound absorber. On this occasion, when a quantity of a flame-retarded organic fiber is less than 10% by weight of the whole, it is difficult to add appropriate transformability and flexibility to the sound absorber. Meanwhile, when a quantity thereof is over 60% by weight of the whole, the heat resistance of the sound absorber decreases, and thus it becomes difficult to suit the sound absorber to a new requirement specification for aircrafts.

On the occasion of containing a high-thermostable inorganic fiber only in the mat-form material, it is desirable that 20 to 80% by weight of a flame-retarded organic fiber is added to the sound absorber. On this occasion, when a quantity of a flame-retarded organic fiber is less than 20% by weight of the whole, it is difficult to add appropriate transformability and flexibility to the sound absorber. Meanwhile, when a quantity thereof is over 80% by weight of the whole, the heat resistance of the sound absorber decreases, and thus it becomes difficult to suit the sound absorber to a new requirement specification for aircrafts.

As a suitable flame-retarded organic fiber, there may be exemplified a meta-aramid fiber, a para-aramid fiber, a melamine fiber, a PBO fiber, a PBI fiber, a polybenzothiazole fiber, a polyarylate fiber, a PES fiber, a LCP fiber, a PPS fiber, a PI fiber, a PEI fiber, a PEEK fiber, a PEK fiber, a PEKK fiber and/or a PAI fiber. In general, the melamine fiber means “BASOPHIL FIBER” (trade name) made by Basophil Fiber Co. The melamine fiber results in a high numerical value on TPP and THL tests by incombustibility and may be combined with one layer of thin thermal liner because of high thermal shielding performance.

In the first manufacture of the adiabatic sound absorber, it is desirable that a low-melting organic fiber is uniformly mixed for matting a web material and a quantity thereof is 10 to 25% by weight of the whole. The low-melting organic fiber is melted with heat-treating in the next process to mat the web material, and therefore it is necessary that this heat-treatment is carried out at higher temperature than a melting point of the organic fiber. When a quantity of this organic fiber is less than 10% by weight, it becomes difficult to obtain a hard mat-form material. Meanwhile, when a quantity thereof is over 25% by weight, the heat resistance of the sound absorber decreases and the sound absorber is apt to generate smoking or gas on the occasion of a test in heat insulation, and therefore the sound absorber fails on a new requirement specification of an acoustic material for aircrafts.

The low-melting organic fiber is generally a thermoplastic fiber such as polyester, polypropylene or acrylic fiber, a composite fiber of these thermoplastic fibers or the like, whose melting point is about 110 to 150° C. It is preferable that a composite fiber made of a low-melting organic fiber and a high-melting organic fiber is a double-layer type including a core-sheath type or a paratactic type, in which the low-melting organic fiber only is melted and the high-melting organic fiber maintains its shape at a heating temperature on the occasion of the heat-treatment. It is therefore possible to attain to matting a web material surely owing to keeping a prototype of the fiber.

In the second manufacture of adiabatic sound absorber, a heat-resistant resin binder may be applied to one or both sides of a web material by spraying, roll-coating or dipping and a quantity thereof is 10 to 25% by weight by dry measure of the whole, instead of addition of the low-melting organic fiber. The resin binder useful for this resin treatment is generally aqueous thermoplastic dispersion such as polyester, polypropylene or acrylic resin or thermosetting paint such as phenol paint, which may contain phosphorus flame retardant or may be stabilized by adding a surface-active agent. An amount of the applied resin is 5 to 200 g/m², preferably 10 to 50 g/m². The painted resin is dried in the next heating process to attain to matting the web material by heat-treating the next process. It is therefore possible to obtain a resin-bonded mat-form material.

It is possible to add liquid water repellent to the web material. It is preferable to supply the sound absorber with water repellency by drying the water repellent. On the one hand, the water repellent may be added before matting the web. The web is then dried on the occasion of the heat treatment to supply the sound absorber with water repellency. On the other hand, the hard mat-form material obtained may be waterproofed after the heat melting treatment for matting the web. The water repellent used, for instance, aqueous fluororesin is inorganic and/or organic chemicals on the market. The waterproof processing may be carried out by one of spraying, roll-coating, dipping and the like.

The water repellent may be also added to the web material simultaneously with the resin binder. On this occasion, the water repellent and the resin binder may be simultaneously added before matting the web to supply the sound absorber with water repellency by drying the water repellent at the time of the heat treatment.

As for a raw fibers composed of inorganic and organic fibers, it is also possible to treat it with water repellent, flame retarder and the like in advance of forming a web with carding. In the waterproof processing, for example, there can be obtained more bulky mat-form material in a case in which the raw fibers is treated with chemicals beforehand, as compared with a case of an after-treatment with chemicals. On the occasion of flame resistant processing, it is preferable to treat a low-melting organic fiber with flame retarder beforehand, so that the flame resistance of the adiabatic sound absorber, especially the anti-flame propagation on the surface thereof is considerably improved. The chemicals used here is not particularly limited and may be selected from aqueous or solvent-soluble fluorine water repellent, aqueous or solvent-soluble silicone water repellent or aqueous dispersion of the flame retarder such as phosphorus-nitrogen retarders. It is thus preferable to use aqueous retarder in respect of processability. On the occasion of treatment of the raw fibers with chemicals, for example, the predetermined amount of commercial aqueous phosphorus water repellent and/or phosphorus flame retardant are added to the raw fibers by spraying or the like, which is dried well to finish the web through a carding machine. On this occasion, there should be cautious about defective carding if drying of the raw fibers is insufficient.

Instead of the preliminary flameproofing of the raw fibers, a flame-resistant resin may be painted on one or both sides of the obtained sound absorber. This treatment is preferable on account of improving anti-flame propagation on the surface. The resins used here is not particularly limited and may be selected from polyester or acryl resin containing phosphorus, phosphorus-nitrogen or silica flame retarder or the like. Means for adding these flame retarders is not particularly limited and may be selected from spraying or coating aqueous dispersion or scattering fine particles. It is desirable that the addition amount of the resin is about 0.5 to 50 g/m², preferable 1 to 10 g/m² when requesting the anti-flame propagation only, or 10 to 40 g/m² when requesting the hardness. When the addition amount of the resin is less than 0.5 g/m², the anti-flame propagation is not improved. Meanwhile, when it is above 50 g/m², the weight of the sound absorber becomes heavier and the sound absorber increases in costs.

It is preferable that the sound absorber is 8 to 50 mm in thickness. When the thickness is less 8 mm, an interior working becomes troublesome because it is too thin to attach on the inside of interior of automobiles or airplanes. When the thickness is above 50 mm, the working also gets troublesome because it becomes difficult to transform the sound absorber. On the mat-form sound absorber, it is preferable that the surface thereof is smoothed furthermore by needle-punching, singeing or calendaring or the like, which can improve the fire spread-proof performance. Especially, it is much preferable that the sound absorber is treated with needle-punching, which can improve the strength of the sound absorber too.

In the sound absorber of the present invention, a face sheet composed of inorganic woven or unwoven cloth may be attached to the mat-form material with a nonflammable resin. This face sheet is selected from a glass, carbon or ceramic fiber or the like and the mat-form material is similar to the mentioned above. In case of laminating this face sheet to the sound absorber, attaching working becomes easy because dropout of fiber chips such as glass fiber chips decreases in amount even if it is cut off or transformed while attaching to aircrafts or railroad cars.

With respect to the new requirement specification for aircrafts, a backside heating value is 2 W/cm² or less for 4 minutes on a fire resistance of a mat-form material, which is provided for by FAR 25.856(b). It is also necessary for a mat-form material to survive at about 1100° C. for 4 minutes so as to fulfill a condition predetermined by FAR 25.856(b) though a heat-resistant temperature is not provided for. The sound absorber of the present invention is suitable for the severe requirement specification of non-woven fabric for aircrafts.

### EFFECT OF THE INVENTION

An adiabatic sound absorber according to the present is almost perfectly nonflammable and has high thermal insulation performance and sound absorbency because a primary component of the mat-form material is a high-thermostable inorganic fiber and an organic component thereof is flame-retarded. The adiabatic sound absorber of the present invention may therefore be used for an acoustic material for various automobile and railroad cars, and furthermore is suitable for a new severe requirement specification for aircrafts.

The adiabatic sound absorber of the present invention has higher safety than before on the occasion of the arrangement in an automobile and railroad cars, an aircraft and the like owing to the adaptation to the severe requirement specification for aircrafts, which can be expected to trade voluminously in goods for an aircraft. The adiabatic sound absorber may be also applied sufficiently to rapid-transit railroad cars in various nations conforming to the British Standard for cars.

It is possible to transform the adiabatic sound absorber of the present invention on the occasion of an arrangement thereof by adding the relatively flexible flame-retarded organic fiber to the relatively rigid thermostable inorganic fiber. The adiabatic sound absorber of the present invention may be processed to an entirely uniform mat-form material with heat treatment only, whose component fibers hardly snap off on the occasion of the after processing, by mixing uniformly a small amount of the low-melting organic fiber or adding a resin binder. The adiabatic sound absorber of the present invention is a soft and handy mat-form material, which makes hardly a working environment worse owing to few falling of fibers when cutting off or transforming it in case of the execution.

### EXAMPLE 1

The present invention is now illustrated on the basis of examples, but the present invention will not be limited to the examples. In the following, a process for manufacturing an adiabatic sound absorber is illustrated.

70% of a silica fiber cut into 51 mm in length as a high-thermostable inorganic fiber, 15% of a meta-aramid fiber, “NOMEX” made by E.I. du Pont de Nemours and Company, as a flame-retarded organic fiber and 15% of a polyester core-sheath composite fiber, “SAFMET” made by Toray Industries, Inc., as a low-melting organic fiber were mixed. A web of 250 g/m² was formed with carding, which was treated with heating at 160° C. for 4 minutes to obtain a hard mat-form material of 20 mm in thickness. The mat-form material thus obtained was subsequently waterproofed by means of aqueous fluorine water repellent.

### EXAMPLE 2

50% of a silica fiber made in China as a high-thermostable inorganic fiber, 25% of a melamine fiber, “BASOPHIL” made by Basophil Fiber Co., as a flame-retarded organic fiber and 25% of an organic fiber having a low melting point were employed. By the same treatment as Example 1 with the exception of these raw fibers, there was prepared a hard mat-form material.

### EXAMPLE 3

70% of a S-glass fiber, “T-GLASS” made by Nitto Boseki Co., Ltd., cut into 51 mm in length as a high-thermostable inorganic fiber, 15% of a para-aramid fiber, “KEVLAR” made by Du pont-Toray co., Ltd., as a flame-retarded organic fiber and 15% of the same composite fiber as Example 1 were employed. By the same treatment as Example 1 with the exception of these raw fibers, there was prepared a hard mat-form material.

### EXAMPLE 4

70% of a silica fiber cut into 51 mm in length as a high-thermostable inorganic fiber, and 30% of a PBO fiber, “ZYLON” made by Toyobo Co., Ltd., as a flame-retarded organic fiber were mixed to form a web of 250 g/m² with air-laying. Polyester dispersion containing phosphorus flame retardant was subsequently sprayed on and permeated into the web, which was dried to obtain a resin-bonded mat-form material of 20 mm in thickness. The mat-form material thus obtained was waterproofed by means of water repellents for inorganic and organic fibers together.

### EXAMPLE 5

30% of a silica fiber, 45% of a meta-aramid fiber and 25% of an organic fiber having a low melting point were employed. By the same treatment as Example 1 with the exception of these raw fibers, there was prepared a hard mat-form material.

### Comparison 1

A commercial glass mat, “WHITE ROLL” made by MAG Mat Co., Ltd., was treated in the same way as Example 1. The hard mat-form material was then waterproofed.

### Comparison 2

70% of an E-glass fiber cut into 51 mm in length and 30% of a meta-aramid fiber, “NOMEX”, were mixed to form a web of 250 g/m² with air-laying. Polyester dispersion containing phosphorus flame retardant was subsequently sprayed on and permeated into the web, which was dried to obtain a resin-bonded mat-form material of 20 mm in thickness. The mat-form material thus obtained was waterproofed by means of water repellents for inorganic and organic fibers together.

### Comparison 3

70% of a stainless steel fiber, “NASLON” made by Nippon Seisen Co., Ltd., cut into 5 mm in length, 15% of ameta-aramid fiber, “NOMEX”, and 15% of a polyester core-sheath composite fiber, “SAFMET”, were mixed to form a web of 250 g/m² with carding. The web was treated with heating at 160° C. for 4 minutes to obtain a hard mat-form material of 20 mm in thickness. The mat-form material thus obtained was subsequently waterproofed by means of water repellents for inorganic and organic fibers together.

About the mat-form materials of Examples 1 to 5 and Comparisons 1 to 3, the result of evaluating heat resistance and thermal insulation performance thereof is shown in the following Table 1. With respect to this result, the samples of Examples 1 to 5 were excellent in heat resistance and adiabaticity together. Meanwhile, the samples of Comparisons 1 and 2 were holed for about 30 seconds from the beginning of the combustion test. It was also judged that the sample of Comparison 3 was sufficient for heat resistance, but insufficient for adiabaticity because the ambient temperature behind the sample rose up during the test.

TABLE 1

| | | | web forming | fiber locked | | |
|---|---|---|---|---|---|---|
| | ratio (weight %) | | means | form | thermostability | adiabaticity |
| Example 1 | silica | 70 | carding | hard mat | ◯ | ◯ |
| | meta-aramid | 15 | | | | |
| | low-melting PET | 15 | | | | |
| Example 2 | silica | 50 | carding | hard mat | ◯ | ◯ |
| | melamine | 25 | | | | |
| | low-melting PET | 25 | | | | |
| Example 3 | S-glass | 70 | carding | hard mat | ◯ | ◯ |
| | para-aramid | 15 | | | | |
| | low-melting PET | 15 | | | | |
| Example 4 | silica | 70 | air-laying | resin-bond | ◯ | ◯ |
| | PBO | 30 | | | | |
| Example 5 | silica | 30 | carding | hard mat | ◯ | ◯ |
| | meta-aramid | 45 | | | | |
| | low-melting PET | 25 | | | | |
| Comp. 1 | E-glass | 100 | — | no binder | X | — |
| | (glass wool) | | | | | |
| Comp. 2 | E-glass | 70 | air-laying | resin-bond | X | — |
| | meta-aramid | 30 | | | | |
| Comp. 3 | stainless steel | 70 | carding | hard mat | ◯ | X |
| | meta-aramid | 15 | | | | |
| | low-melting PET | 15 | | | | |

### Evaluation of Thermostability and Adiabaticity in Table 1

The mat-form sample with the dimensions of 10 cm or more square was put on a horizontal rack. A gas burner was so controlled that the blaze thereof was 50 to 80 mm in height and the inner flame was 10 to 15 mm in height. The height of the rack or the gas burner was so adjusted that about 10 mm part of the burner blaze could come in contact with the back of the sample on the rack. The blaze of the gas burner was allowed to touch roughly the center of the mat-form sample on the rack for 5 minutes. In the experiment for five-minutes, it was judged that the thermostability was high (“◯”) when the sample was not holed at all and that the thermostability is low (“X”) when it was holed even a little. During this experiment, it was judged that the adiabaticity is high (“◯”) when it was possible to hold a hand up behind the sample and that the adiabaticity was low (“X”) when it was impossible to hold a hand up behind the sample.

### EXAMPLE 6

As for raw fibers, a silica fiber as a high-thermostable inorganic fiber, a meta-aramid fiber as a flame-retarded organic fiber and a polyester core-sheath composite fiber as a low-melting organic fiber were employed, respectively. On the silica fiber, aqueous fluorine water repellent was so sprayed that the addition of the repellent to the dried fiber reached 1% by weight, and moreover the silica fiber was so dried with heating that the moisture content thereof was reduced to 2% by weight or less. On the meta-aramid fiber and the low-melting polyester fiber, the same aqueous fluorine water repellent as above-mentioned and phosphorus-nitrogen flame retardant dispersion with polyester binder were also so sprayed that the additions of the repellent and the retardant reached 1% by weight, respectively, and moreover the meta-aramid and polyester fibers were so dried that the moisture content thereof was reduced to 2% by weight or less, as above-mentioned.

50% of the silica fiber, 30% of the meta-aramid fiber and 20% of the polyester fiber, which was chemical-treated, were mixed to form a web of 250 g/m² with carding. The both side of the web was punched with needles under the condition that the prick depth of the needles was 6 mm and the needle density was 7 pricks/cm², and moreover was treated with heating at 170° C. for 3 minutes to obtain a hard mat-form material of 20 mm in thickness. The mat-form material thus obtained accomplished all acceptable levels with respect to evaluation of the heat resistance, water repellency and anti-flame propagation thereof.

### EXAMPLE 7

As for raw fibers, a silica fiber as a high-thermostable inorganic fiber, a meta-aramid fiber as a flame-retarded organic fiber and a polyester core-sheath composite fiber as a low-melting organic fiber were employed, respectively. On these fibers, aqueous fluorine water repellent was so sprayed that the addition of the repellent to the dried fiber reached 1% by weight, and moreover the fibers were so dried with heating that the moisture content thereof was reduced to 2% by weight or less, respectively.

50% of the silica fiber, 30% of the meta-aramid fiber and 20% of the polyester fiber, which was chemical-treated, were mixed to form a web of 250 g/m² with carding. The both side of the web was punched with needles under the condition that the prick depth of the needles was 6 mm and the needle density was 7 pricks/cm², and moreover was treated with heating at 180° C. for 5 minutes to obtain a hard mat-form material of 20 mm in thickness. The mat-form material thus obtained accomplished all acceptable levels with respect to evaluation of the heat resistance, water repellency and anti-flame propagation thereof.

As for evaluation of water repellency in Examples 6 and 7, the sample with dimensions of 25 cm square was put under water for 15 minutes and taken out from water, and moreover was stood for one minute, in accordance with ASTM C1511-04 Standard. The sample accomplished an acceptable level when the weight increase thereof was 20 grams or less. As for evaluation of anti-flame propagation, a blaze of a gas burner was allowed to touch the surface of the sample for 2 minutes. The sample accomplished an acceptable level when the residual burning time thereof was one second or less after separating the blaze from the sample.

1-9. (canceled)

10. An adiabatic sound absorber, for which the mat-form material is not holed at all by taking a combustion test in contacting a blaze of a gas burner for five minutes and it is possible to hold a hand up behind the mat-form material during the combustion test, the adiabatic sound absorber with high thermal resistance prepared by:
mixing uniformly 20 to 80% of a high-thermostable inorganic fiber whose high-temperature strength is maintained above 1000° C., 10 to 60% of a flame-retarded organic fiber whose thermal melting or decomposition temperature is above 350° C. and 10 to 25% of an organic fiber having a low melting point; and
treating the obtained woolly felt with heating to transform the whole into the mat-form material of 8 to 50 mm in thickness.

11. The adiabatic sound absorber as recited in claim 10, wherein the woolly felt is impregnated with liquid water-repellent to add water repellency to the woolly felt.

12. The adiabatic sound absorber as recited in claim 10, wherein the high-thermostable inorganic fiber is at least one fiber selected from the group consisting of a silica fiber, an S-glass fiber, a silicon carbide fiber, a boron fiber, an alumina silicate fiber, an alkaline titanate fiber and a ceramic fiber.

13. The adiabatic sound absorber as recited in claim 12, wherein the high-thermostable inorganic fiber is a silica fiber.

14. The adiabatic sound absorber as recited in claim 10, wherein the flame-retarded organic fiber is at least one fiber selected from the group consisting of a meta-aramid fiber, a para-aramid fiber, a melamine fiber, a polybenzoxazole fiber, a polybenzimidazole fiber, a polybenzothiazole fiber, a polyarylate fiber, a polyethersulfone fiber, a liquid crystalline polyester fiber, a polyimide fiber, a polyetherimide fiber, a polyether ether ketone fiber, a polyether ketone fiber, a polyether ketone ketone fiber and a polyamide-imide fiber.

15. The adiabatic sound absorber as recited in claim 10, wherein each raw fiber is treated with chemicals selected from the group consisting of a water repellent, a flame retardant and a mixture of a water repellent and a flame retardant before mixing the raw fibers.

16. The adiabatic sound absorber as recited in claim 10, wherein furthermore a flame-retarded resin is added to at least one surface of the adiabatic sound absorber.

17. The adiabatic sound absorber as recited in claim 10, wherein furthermore a surface smoothing treatment is applied to the mat-form sound absorbing material, the treatment being selected from the group consisting of needle-punching, singeing and calendering.

18. An adiabatic sound absorber, for which the mat-form material is not holed at all by taking a combustion test in contacting a blaze of a gas burner for five minutes and it is possible to hold a hand up behind the mat-form material during the combustion test, the adiabatic sound absorber with high thermal resistance prepared by:
mixing uniformly 20 to 80% of a high-thermostable inorganic fiber whose high-temperature strength is maintained above 1000° C. and 10 to 60% of a fire-resistant organic fiber whose thermal melting or decomposition temperature is above 350° C.;
impregnating the obtained woolly felt with 10 to 25% by dry measure of a thermostable resin binder; and
treating the woolly felt with heating to transform the whole into the mat-form material of 8 to 50 mm in thickness.

19. The adiabatic sound absorber as recited in claim 18, wherein the woolly felt is impregnated with liquid water-repellent to add water repellency to the woolly felt.

20. The adiabatic sound absorber as recited in claim 18, wherein the high-thermostable inorganic fiber is at least one fiber selected from the group consisting of a silica fiber, an S-glass fiber, a silicon carbide fiber, a boron fiber, an alumina silicate fiber, an alkaline titanate fiber and a ceramic fiber.

21. The adiabatic sound absorber as recited in claim 20, wherein the high-thermostable inorganic fiber is a silica fiber.

22. The adiabatic sound absorber as recited in claim 18, wherein the flame-retarded organic fiber is at least one fiber selected from the group consisting of a meta-aramid fiber, a para-aramid fiber, a melamine fiber, a polybenzoxazole fiber, a polybenzimidazole fiber, a polybenzothiazole fiber, a polyarylate fiber, a polyethersulfone fiber, a liquid crystalline polyester fiber, a polyimide fiber, a polyetherimide fiber, a polyether ether ketone fiber, a polyether ketone fiber, a polyether ketone ketone fiber and a polyamide-imide fiber.

23. The adiabatic sound absorber as recited in claim 18, wherein each raw fiber is treated with chemicals selected from the group consisting of a water repellent, a flame retardant and a mixture of a water repellent and a flame retardant before mixing the raw fibers.

24. The adiabatic sound absorber as recited in claim 18, wherein furthermore a flame-retarded resin is added to at least one surface of the adiabatic sound absorber.

25. The adiabatic sound absorber as recited in claim 18, wherein furthermore a surface smoothing treatment is applied to the mat-form sound absorbing material, the treatment being selected from the group consisting of needle-punching, singeing and calendering.
